(19) United States
(12) Patent Application Publication
(10) Pub. No.: US 2010/0177336 A1
(43) Pub. Date: Jul. 15, 2010

(54) IMAGE FORMING APPARATUS AND CONTROL METHOD OF THE SAME

(75) Inventor: Shinji Ono, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/686,661

(22) Filed: Jan. 13, 2010

Related U.S. Application Data
(60) Provisional application No. 61/145,017, filed on Jan. 15, 2009.

(51) Int. Cl. G06F 15/00

(52) U.S. Cl. 358/1.13

(57) ABSTRACT

Image data C1, M1, Y1, and K1 are analyzed. Functions for control for the image data C1, M1, Y1, and K1 are variably set according to results of the analysis, respectively. The image data C1, M1, Y1, and K1 are converted into image data C2, M2, Y2, and K2 according to arithmetic operations of the set functions.

### CROSS-REFERENCE TO RELATED APPLICATION

This application is based upon and claims the benefit of priority from U.S. Provisional Application No. 61/145,017, filed Jan. 15, 2009, the entire contents of which are incorporated herein by reference.

### TECHNICAL FIELD

An embodiment disclosed therein relates to an image forming apparatus having a function of controlling image data C, M, Y, and K of a bitmap format and a control method of the image forming apparatus.

### BACKGROUND

An image forming apparatus can print image data scanned from an original document and image data input from an external apparatus (e.g., a personal computer) connected to the image forming apparatus through a network.

The scanned image data and the image data input from the external apparatus are page description language (PDL) data.

The image forming apparatus converts, with a raster image processor (RIP) incorporated therein, the PDL data into plural image data of the bitmap format that a printer (a print engine) can understand (rendering processing). The image data are image data C corresponding to a cyan image, image data M corresponding to a magenta image, image data Y corresponding to a yellow image, and image data K corresponding to a black image.

It is conceivable to adopt a conversion data table as means for appropriately controlling the image data C, M, Y, and K. However, since the image data C, M, Y, and K are multi-value data including density of “256” gradations, a large-capacity memory is necessary to adopt the conversion data table. This causes an increase in cost.

### SUMMARY

An image forming apparatus disclosed herein includes:

an analysis section configured to analyze plural image data;

a configuration section configured to variably set functions for control for the image data according to analysis results of the analysis section, respectively; and

an operation section configured to control the image data according to arithmetic operations of the functions set by the configuration section, respectively.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate presently an embodiment of the invention, and together with the general description given above and the detailed description of the preferred embodiment given below, serve to explain the principles of the invention.

FIG. 1 is a block diagram of a control circuit according to an embodiment of the present invention;

FIG. 2 is a block diagram of an image processing circuit in a controller shown in FIG. 1;

FIG. 3 is a flowchart for explaining the operation of the image processing circuit shown in FIG. 2;

FIG. 4 is a time chart of transfer timing of data in the image processing circuit shown in FIG. 2; and

FIG. 5 is a graph of an example of functions in the embodiment.

### DETAILED DESCRIPTION

An embodiment of the present invention is explained below with reference to the accompanying drawings.

An image forming apparatus according to the present invention includes a scanning unit (a scanning unit 3 explained later) configured to optically scan an image of an original document and a process unit (a process unit 8 explained later) configured to form a developer image corresponding to the image scanned by the scanning unit on a paper sheet, which is an object on which the developer image is fixed. The specific configuration of the image forming apparatus is described in U.S. application Ser. No. 10/602,920 filed earlier. Therefore, explanation of the configuration is omitted.

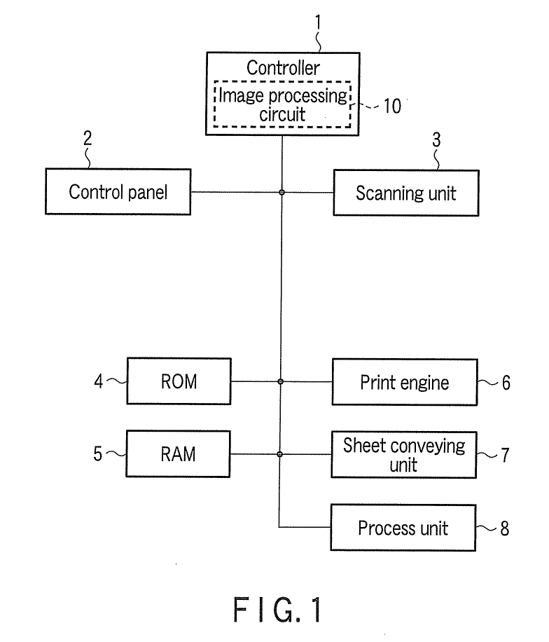

A control circuit for the image forming apparatus is shown in FIG. 1.

A control panel 2, a scanning unit 3, a ROM 4 for control program storage, a RAM 5 for data storage, a print engine 6, a sheet conveying unit 7, and a process unit 8 are connected to a controller 1. The controller 1 controls the control panel 2, the scanning unit 3, the print engine 6, the sheet conveying unit 7, and the process unit 8 according to a control program stored in the ROM 4.

The scanning unit 3 scans image data from an original document placed on a document table. The image data is page description language (PDL) data. An image processing circuit 10 in the controller 1 converts, with a raster image processor (RIP) incorporated therein, the PDL data into plural image data C1, M1, Y1, and K1 of a bitmap format that the print engine 6 can understand (rendering processing). C1 indicates image data corresponding to a cyan image, M1 indicates image data corresponding to a magenta image, Y1 indicates image data corresponding to a yellow image, and K1 indicates image data corresponding to a black image. The image processing circuit 10 has a function of converting the converted image data C1, M1, Y1, and K1 into image data C2, M2, Y2, and K2 subjected to a predetermined change.

The print engine 6 emits laser beams corresponding to the image data C2, M2, Y2, and K2 converted by the image processing circuit 10 to thereby expose photoconductive drums of the process unit 8 to the laser beams. The sheet conveying unit 7 includes a conveying mechanism for a paper sheet and a driving circuit for the conveying mechanism. The process unit 8 develops, with toners, electrostatic latent images formed on the photoconductive drums by the exposure and transfers the developer images onto the paper sheet.

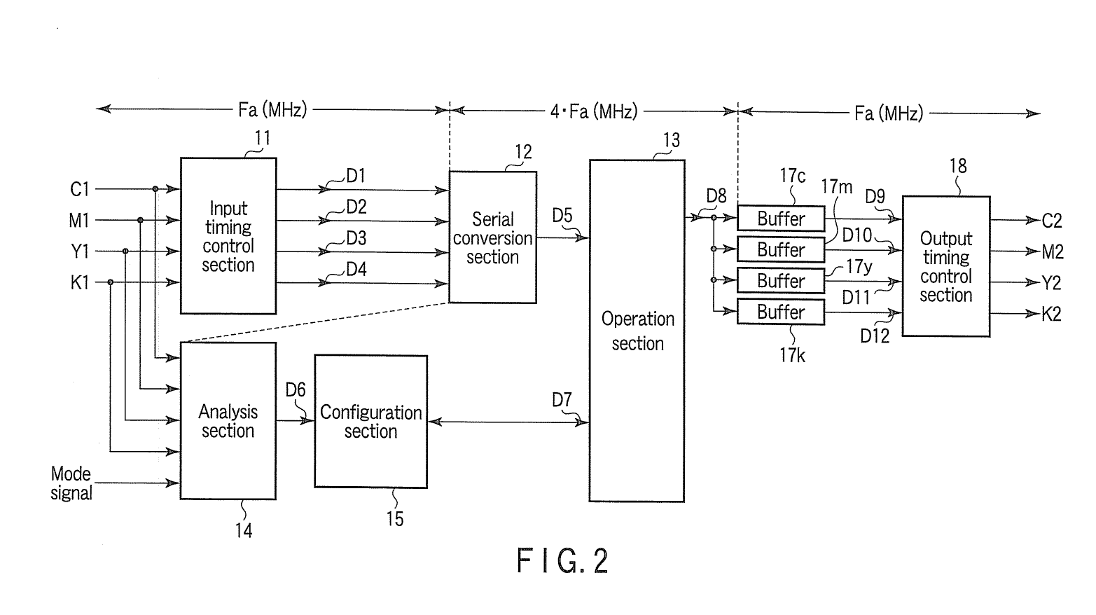

A main part of the image processing circuit 10 is shown in FIG. 2.

The image data C1, M1, Y1, and K1 converted from the PDL data are input to an input timing control section 11 in synchronization with one another. The input timing control section 11 outputs the input image data C1, M1, Y1, and K1 as data D1, D2, D3, and D4 in parallel at predetermined timing while temporarily storing the image data C1, M1, Y1, and K1. In this case, the input timing control section 11 operates on the basis of a clock signal having a frequency Fa and outputs the data D1, D2, D3, and D4 in parallel at each period of the clock signal. The output data D1, D2, D3, and D4 are input to a serial conversion section 12.

The serial conversion section 12 serially converts the input data D1, D2, D3, and D4 and outputs the data as data D5. In this case, the serial conversion section 12 operates on the basis of a clock signal having a frequency 4·Fa four times as high as the frequency Fa and outputs the data D5 at each period of the clock signal. The output data D5 is input to an operation section 13.

The image data C1, M1, Y1, and K1 converted from the PDL data are input to an analysis section 14 in synchronization with one another. The analysis section 14 analyzes the densities of the input image data C1, M1, Y1, and K1 and sequentially outputs data D6 for function designation corresponding to results of the analysis and image forming modes of the image forming apparatus. In this case, the analysis section 14 operates on the basis of the clock signal having the frequency 4·Fa and outputs the data D6 at each period of the clock signal. The output data D6 is input to a configuration section 15.

The image forming modes are at least an image forming mode for photographs and an image forming mode for characters. The control panel 2 supplies a mode signal for informing the analysis section 14 of a setting state of the image forming modes to the analysis section 14. The mode signal is logic “0” when the image forming mode for photographs is set. The mode signal is logic “1” when the image forming mode of characters is set.

The configuration section 15 sequentially variably sets functions for control for the image data C1, M1, Y1, and K1 according to the data D6 output from the analysis section 14 and outputs the functions as data D7. In this case, the configuration section 15 operates on the basis of the clock signal having the frequency 4·Fa and outputs the data D7 at each period of the clock signal. The output data D7 is input to the operation section 13.

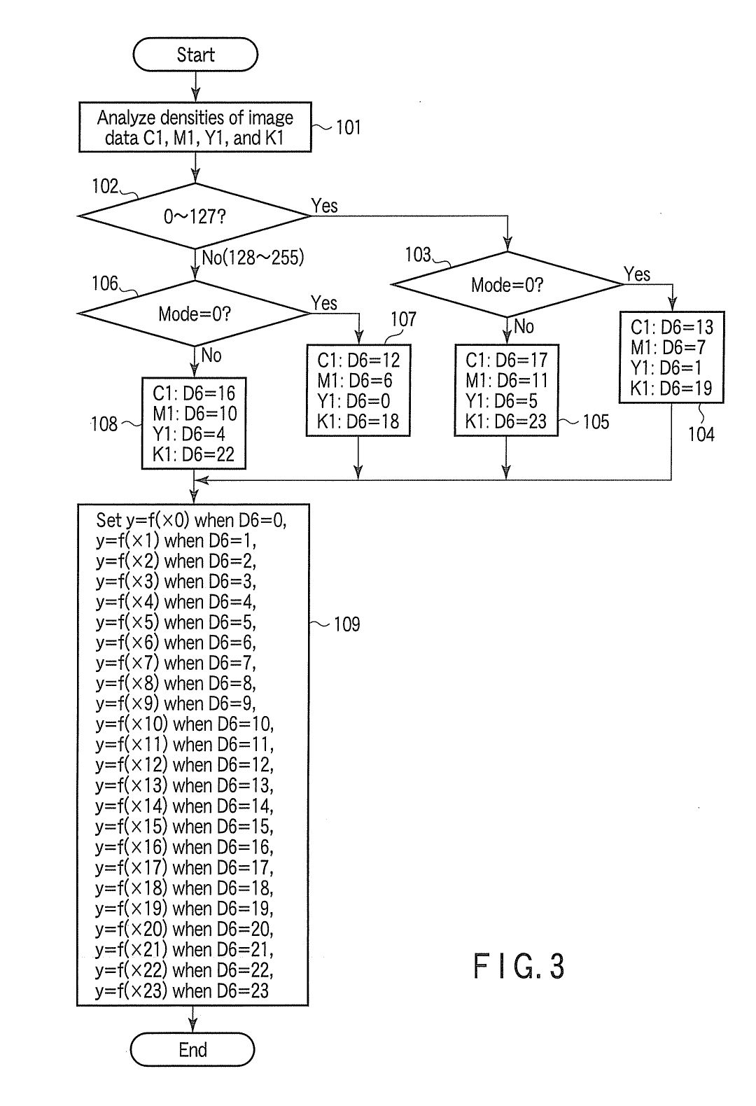

The operation of the analysis section 14 and the configuration section 15 is shown in a flowchart of FIG. 3.

The analysis section 14 analyzes the densities of the image data C1, M1, Y1, and K1 (step 101). If the analyzed density of the image data C1 is any one of gradations “0” to “127” (YES in step 102) and if the mode signal is logic “0” (YES in step 103), the analysis section 14 determines a numerical value “13” as the data D6 for function designation for the image data C1 (step 104). If the analyzed density of the image data M1 is any one of the gradations “0” to “127” (YES in step 102) and if the mode signal is logic “0” (YES in step 103), the analysis section 14 determines a numerical value “7” as the data D6 for function designation for the image data M1 (step 104). If the analyzed density of the image data Y1 is any one of the gradations “0” to “127” (YES in step 102) and if the mode signal is logic “0” (YES in step 103), the analysis section 14 determines a numerical value “1” as the data D6 for function designation for the image data Y1 (step 104). If the analyzed density of the image data K1 is any one of the gradations “0” to “127” (YES in step 102) and if the mode signal is logic “0” (YES in step 103), the analysis section 14 determines a numerical value “19” as the data D6 for function designation for the image data K1 (step 104).

If the analyzed density of the image data C1 is any one of the gradations “0” to “127” (YES in step 102) and if the mode signal is logic “1” (NO in step 103), the analysis section 14 determines a numerical value “17” as the data D6 for function designation for the image data C1 (step 105). If the analyzed density of the image data M1 is any one of the gradations “0” to “127” (YES in step 102) and if the mode signal is logic “1” (NO in step 103), the analysis section 14 determines a numerical value “11” as the data 06 for function designation for the image data M1 (step 105). If the analyzed density of the image data Y1 is any one of the gradations “0” to “127” (YES in step 102) and if the mode signal is logic “1” (NO in step 103), the analysis section 14 determines a numerical value “5” as the data D6 for function designation for the image data Y1 (step 105). If the analyzed density of the image data K1 is any one of the gradations “0” to “127” (YES in step 102) and if the mode signal is logic “1” (NO in step 103), the analysis section 14 determines a numerical value “23” as the data D6 for function designation for the image data K1 (step 105).

If the analyzed density of the image data C1 is any one of gradations “128” to “255” (NO in step 102) and if the mode signal is logic “0” (YES in step 106), the analysis section 14 determines a numerical value “12” as the data D6 for function designation for the image data C1 (step 107). If the analyzed density of the image data M1 is any one of the gradations “128” to “255” (NO in step 102) and if the mode signal is logic “0” (YES in step 106), the analysis section 14 determines a numerical value “6” as the data 06 for function designation for the image data M1 (step 107). If the analyzed density of the image data Y1 is any one of the gradations “128” to “255” (NO in step 102) and if the mode signal is logic “0” (YES in step 106), the analysis section 14 determines a numerical value “0” as the data D6 for function designation for the image data Y1 (step 107). If the analyzed density of the image data K1 is any one of the gradations “128” to “255” (NO in step 102) and if the mode signal is logic “0” (YES in step 106), the analysis section 14 determines a numerical value “18” as the data D6 for function designation for the image data K1 (step 107).

If the analyzed density of the image data C1 is any one of gradations “128” to “255” (NO in step 102) and if the mode signal is logic “1” (NO in step 106), the analysis section 14 determines a numerical value “16” as the data D6 for function designation for the image data C1 (step 108). If the analyzed density of the image data M1 is any one of the gradations “128” to “255” (NO in step 102) and if the mode signal is logic “1” (NO in step 106), the analysis section 14 determines a numerical value “10” as the data D6 for function designation for the image data M1 (step 108). If the analyzed density of the image data Y1 is any one of the gradations “128” to “255” (NO in step 102) and if the mode signal is logic “1” (NO in step 106), the analysis section 14 determines a numerical value “4” as the data D6 for function designation for the image data Y1 (step 108). If the analyzed density of the image data K1 is any one of the gradations “128” to “255” (NO in step 102) and if the mode signal is logic “1” (NO in step 106), the analysis section 14 determines a numerical value “22” as the data D6 for function designation for the image data K1 (step 108).

The configuration section 15 variably sets a function for control for the image data C1 according to the data D6 for function designation for the image data C1 (step 109). For example, when the data D6 is the numerical value “0”, the configuration section 15 sets y=f(x0) as the function for control for the image data C1. When the data D6 is the numerical value “1”, the configuration section 15 sets y=f(x1) as the function for control for the image data C1. When the data D6 is the numerical value “2”, the configuration section 15 sets y=f(x2) as the function for control for the image data C1. When the data D6 is the numerical value “23”, the configuration section 15 sets y=f(x23) as the function for control for the image data C1.

Similarly, the configuration section 15 variably sets functions for control for the image data M1, Y1, and K1 according to the data D6 for function designation for the image data M1, Y1, and K1, respectively (step 109).

On the other hand, the operation section 13 converts the data D5, i.e., the image data C1, M1, Y1, and K1 output from the serial conversion section 12 into the image data C2, M2, Y2, and K2 according to an arithmetic operation of the data D7, i.e., the functions output from the configuration section 15.

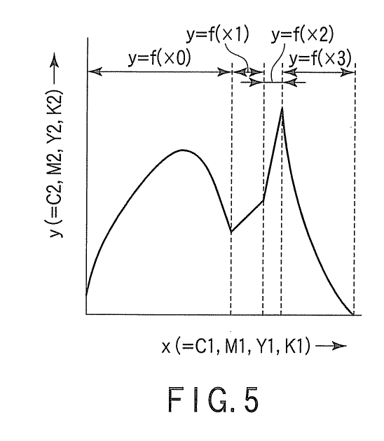

As shown in FIG. 5, the functions y=f(x0), y=f(x1), y=f(x2), and the like are equivalent to a characteristic curve that represents a relation between input x and output y. It is possible to calculate the image data C2, M2, Y2, and K2 as the output y by setting the image data C1, M1, Y1, and K1 as the input x.

The operation section 13 sequentially outputs the calculated image data C2, M2, Y2, and K2 as data D8. The image data C2, the image data M2, the image data Y2, and the image data K2 of the data D8 are respectively input to a buffer 17c, a buffer 17m, a buffer 17y, and a buffer 17k.

The buffer 17c outputs the image data C2 as data

D9 while temporarily storing the image data C2. The buffer 17m outputs the image data M2 as data D10 while temporarily storing the image data M2. The buffer 17y outputs the image data Y2 as data D11 while temporarily storing the image data Y2. The buffer 17k outputs the image data K2 as data D12 while temporarily storing the image data K2. In this case, the buffers 17c, 17m, 17y, and 17k operate on the basis of the clock signal having the frequency Fa and respectively output the data D9, D10, D11, and D12 at each period of the clock signal. The output data D9, D10, D11, and D12 are input to an output timing control section 18.

The output timing control section 18 outputs the data D9, D10, D11, and D12, i.e., the image data C2, M2, Y2, and K2 output from the buffers 17c, 17m, 17y, and 17k in synchronization with one another. The output data D9, D10, D11, and D12 are input to the print engine 6.

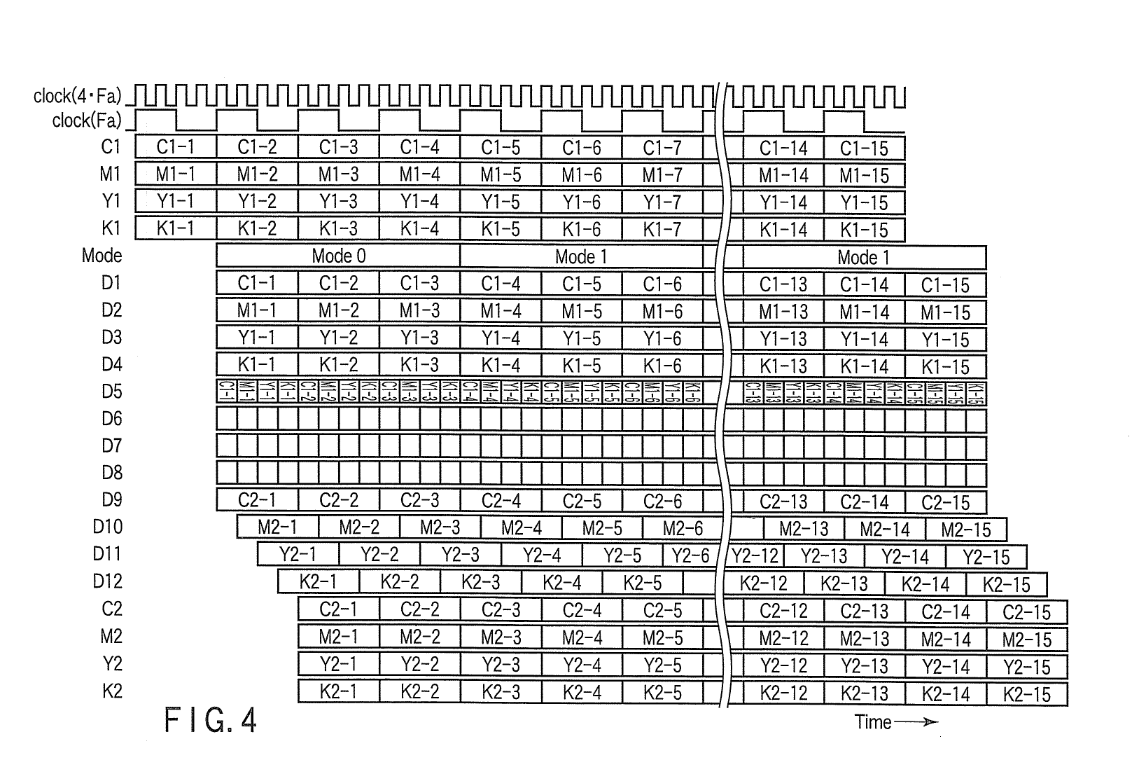

Transfer timing of the data in the image processing circuit 10 is shown in a time chart of FIG. 4.

As explained above, the functions for control for obtaining the image data C2, M2, Y2, and K2 from the image data C1, M1, Y1, and K1 are variably set according to the analysis results of the image data C1, M1, Y1, and K1. This makes it possible to convert the image data C1, M1, Y1, and K1 into desired image data C2, M2, Y2, and K2 without requiring a conversion data table for which a large-capacity memory is used. Since the large-capacity memory is not used, cost does not substantially increase.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
an analysis section configured to analyze plural image data;
a configuration section configured to variably set functions for control for the image data according to analysis results of the analysis section, respectively; and
an operation section configured to control the image data according to arithmetic operations of the functions set by the configuration section, respectively.

2. The apparatus of claim 1, wherein the plural image data are image data C, M, Y, and K of a bitmap format.

3. The apparatus of claim 1, wherein
the analysis section analyzes densities of the image data and outputs data for function designation corresponding to the analyzed densities, and
the configuration section variably sets functions for control for the respective image data according to the data for function designation output from the analysis section, respectively.

4. The apparatus of claim 1, wherein
the analysis section analyzes densities of the image data and outputs data for function designation corresponding to results of the analysis and image forming modes of the apparatus, and
the configuration section variably sets functions for control for the respective image data according to the data for function designation output from the analysis section, respectively.

5. The apparatus of claim 4, wherein the image forming modes of the apparatus are at least an image forming mode for photographs and an image forming mode for characters.

6. An image forming apparatus comprising:
an input timing control section configured to output plural image data, which are input in synchronization with one another, in parallel at predetermined timing while temporarily storing the image data;
a serial conversion section configured to serially convert and output the image data output from the input timing control section;
an analysis section configured to analyze the input image data and sequentially output results of the analysis;
a configuration section configured to sequentially variably set functions for control for the input image data according to the analysis results output from the analysis section;
an operation section configured to control, on the basis of arithmetic operations of the functions variably set by the configuration section, the image data output from the serial conversion section and sequentially output the image data;
plural buffers configured to respectively output the image data output from the operation section while temporarily storing the image data; and
an output timing control section configured to output the image data, which are output from the buffers, in synchronization with one another.

7. The apparatus of claim 6, wherein
the input image data are image data C1, M1, Y1, and K1 of a bitmap format, and
the image data output from the operation section are image data C2, M2, Y2, and K2 of the bitmap format.

8. The apparatus of claim 6, wherein
the analysis section analyzes densities of the input image data and sequentially outputs data for function designation corresponding to results of the analysis, and
the configuration section sequentially variably sets functions for control for the respective input image data according to the data for function designation output from the analysis section.

9. The apparatus of claim 6, wherein
the analysis section analyzes densities of the input image data and sequentially outputs data for function designation corresponding to results of the analysis and image forming modes of the apparatus, and
the configuration section sequentially variably sets functions for control for the respective input image data according to the data for function designation output from the analysis section.

10. The apparatus of claim 9, wherein the image forming modes of the apparatus are at least an image forming mode for photographs and an image forming mode for characters.

11. The apparatus of claim 6, wherein
the input timing control section operates on the basis of a clock signal having a frequency Fa,
the serial conversion section operates on the basis of a clock signal having a frequency 4·Fa four times as high as the frequency Fa,
the analysis section operates on the basis of the clock signal having the frequency 4·Fa,
the configuration section operates on the basis of the clock signal having the frequency 4·Fa,
the operation section operates on the basis of the clock signal having the frequency 4·Fa,
the buffers operate on the basis of the clock signal having the frequency Fa, and
the output timing control section operates on the basis of the clock signal having the frequency Fa.

12. A control method of the image forming apparatus comprising:
analyzing plural image data;
variably setting functions for control for the image data according to results of the analysis; and
controlling the image data according to arithmetic operations of the set functions.

13. The method of claim 12, wherein the plural image data are image data C, M, Y, and K of a bitmap format.

14. The method of claim 12, wherein
the analyzing the image data includes analyzing densities of the image data and outputting data for function designation corresponding to the analyzed densities, and
the variably setting the functions for control includes variably setting functions for control for the respective image data according to the data for function designation, respectively.

15. The method of claim 12, wherein
the analyzing the image data includes analyzing densities of the image data and outputting data for function designation corresponding to results of the analysis and image forming modes of the apparatus, and
the variably setting the functions for control includes variably setting functions for control for the respective image data according to the data for function designation, respectively.

16. The method of claim 15, wherein the image forming modes of the apparatus are at least an image forming mode for photographs and an image forming mode for characters.
